(19) United States
(12) Patent Application Publication
(10) Pub. No.: US 2012/0260463 A1
(43) Pub. Date: Oct. 18, 2012

(54) GRIP ENHANCER

(76) Inventor: Steve Hines, Edgewood, NM (US)

(21) Appl. No.: 13/447,819

(22) Filed: Apr. 16, 2012

Related U.S. Application Data
(60) Provisional application No. 61/476,140, filed on Apr. 15, 2011.

(51) Int. Cl. B25G 1/10

(52) U.S. Cl. 16/430

(57) ABSTRACT

A coil of elastic material can be wrapped around the handle of a utensil to thereby provide an enhanced grip. An ideal material for this application is a food grade or medical grade silicone rubber because this material is relatively inert both chemically and biologically. Other advantageous properties include a wide range of working temperatures and the availability of a variety of grades, colors, and firmness. Material of different grades can be combined to provide rigidity to the coil shape while also providing a compliant surface. Texturing of the inner and/or outer coil surfaces can also provide for better handholds and for a more positive contact between the grip enhancer and the utensil handle.

### CROSS-REFERENCE TO PROVISIONAL PATENT APPLICATION

This application claims the benefit and priority of U.S. Provisional Patent Application 61/476,140 titled “Grip Enhancer” and filed on Apr. 15, 2011 which is herein included by reference in its entirety.

### TECHNICAL FIELD

Embodiments are generally related to household utensils, silicone rubber, food grade and medical grade silicone rubber, and the processing of elastomers, such as silicone rubber, to produce household items.

### BACKGROUND OF THE INVENTION

Attaching a handle to an item is a truly ancient technology and the reasons for doing so need no elaboration. The truest requirement of a good handle is that a person can hold it securely. A handle that is too wide, too thin, or too slippery is of practically no use. Too complicate the matter, people's hands vary in size, strength and dexterity. There are even variations for a single person who can find a certain handle useful during one time period and almost useless at another. For example, a baby or young child can have trouble gripping and controlling a small handle. As the child matures, that same small handle is preferred. Later in life, however, that same person can once again have trouble gripping that handle. Similarly a person wearing gloves might find a larger handle useful.

In the past, numerous solutions have been applied to this problem. Knife hilts have been wrapped in leather or cordage to increase their circumference. Adaptors have been glued over original handles to produce larger handles. As a temporary solution, people have used rags or thick pieces of cloth to more tightly grip an item. All of these solutions have worked adequately for millennia. The classic solutions suffer various drawbacks such as poor sanitation, poor resistance to heat and chemicals, fragility, to high thermal conductance. Therefore, systems and methods providing improved gripping with fewer drawbacks are needed.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is therefore an aspect of the embodiments that a rod of rubbery and elastic material is formed into loops so that, when relaxed, the loops form a coil. Relaxed means that the coil is not wrapped around anything or pulled out of shape. The loops have an inner diameter and an outer diameter. Wrapping or winding the coil around a utensil's handle results in an enhanced handle for the utensil such that a person can hold the coil which in turn holds the handle. The enhanced handle, being rubbery, elastic, and larger than the utensil's handle, provides a more comfortable grip that conforms somewhat to a person's handhold. Note that the coil can be formed directly from uncured material, formed by resetting thermoplastic material, or formed by a combination of these and/or other techniques.

It is also an aspect of the embodiments that the loops return to their relaxed state when the coil is unwrapped from the handle. Silicone rubber is a good material for the enhanced grip because it is elastic, rubbery, and compliant. Food grade silicone rubber is an excellent material for the enhanced grip because it is robust, biologically non-reactive, and easily washable. Silicone rubbers can also have excellent thermal characteristics and high melting points such that they do not melt or deform when in contact with hot pans, oven racks, or similar items.

It is an aspect of some embodiments that different grades of silicone rubber are combined. Different grades of silicone rubber can have different firmness, different elasticity, different color, and other different properties. For example, the rod can consist of a firm core surrounded by a more compliant (less firm) material to therefore provide a somewhat rigid coil shape with a soft and compliant surface. The inner and outer surfaces of the coil can also differ in texture, firmness, color, or in other manners.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a utensil with an enhanced handle in accordance with aspects of the embodiments;

FIG. 2 illustrates a utensil with an enhanced handle wrapped around its handle in accordance with aspects of the embodiments;

FIG. 3 illustrates a grip enhancer in accordance with aspects of the embodiments;

FIG. 4 illustrates a lengthwise cut view of the grip enhancer of FIG. 3 in accordance with aspects of the embodiments;

FIG. 5 illustrates a grip enhancer in its relaxed state and in accordance with aspects of the embodiments;

FIG. 6 illustrates a rod of grip enhancer material having a core layer and two additional layers of material in accordance with aspects of some embodiments; and

FIG. 7 illustrates a partial loop of textured grip material in accordance with aspects of certain embodiments.

### DETAILED DESCRIPTION

The particular values and configurations discussed in these non-limiting examples can be varied and are cited merely to illustrate at least one embodiment and are not intended to limit the scope thereof.

A coil of elastic material can be wrapped around the handle of a utensil to thereby provide an enhanced grip. An ideal material for this application is a food grade or medical grade silicone rubber because this material is relatively inert both chemically and biologically. Other advantageous properties include a wide range of working temperatures and the availability of a variety of grades, colors, and firmness. Material of different grades can be combined to provide rigidity too the coil shape while also providing a compliant surface. Texturing of the inner and/or outer coil surfaces can also provide for better handholds and for a more positive contact between the grip enhancer and the utensil handle.

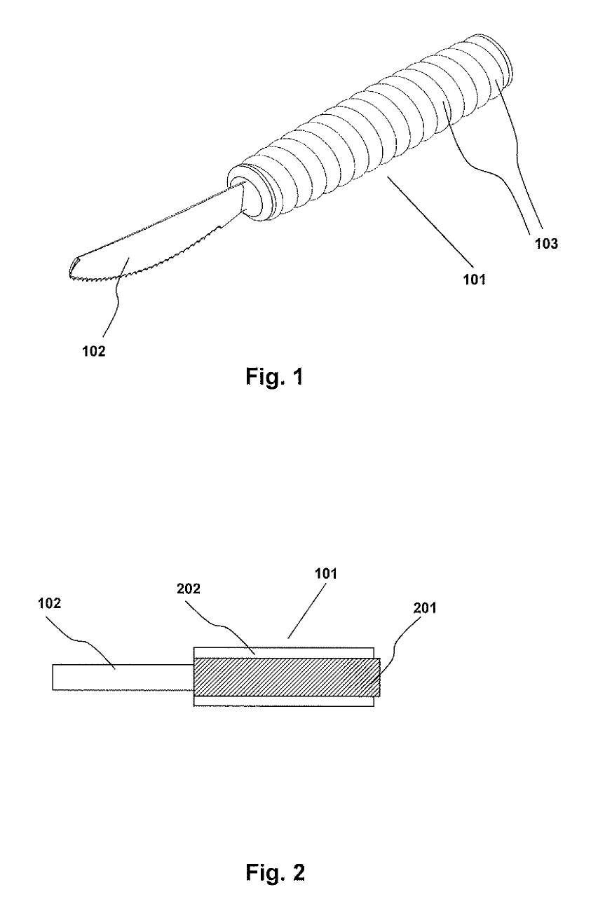

FIG. 1 illustrates a utensil 102 with an enhanced handle 101 in accordance with aspects of the embodiments. A grip enhancer is a coil shaped device consisting of elastic and rubbery material. Wrapping the grip enhancer around the utensil's handle results in an enhanced handle 101. The grip enhancer has a number of loops 103 of the grip material. FIG. 2 also illustrates a utensil 102 with an enhanced handle 101 produced by wrapping a grip enhancer 202 around the utensil handle 201.

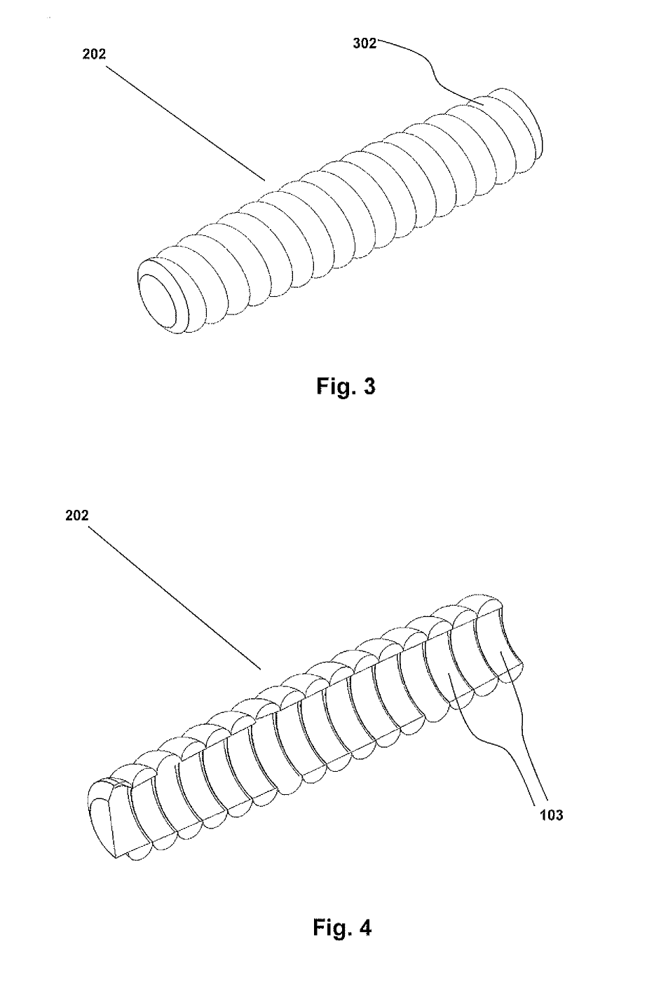

FIG. 3 illustrates a grip enhancer 202 in accordance with aspects of the embodiments. The grip enhancer 202 is a coil of material having many loops 302 that can be wound around a handle (FIG. 2, element 201).

FIG. 4 illustrates a lengthwise cut view of the grip enhancer 202 of FIG. 3 in accordance with aspects of the embodiments. The inside surface of the loops 103 can be seen to be flattened in this embodiment. The flatness is one texture that can help improve how well the grip enhancer clings to a utensil handle.

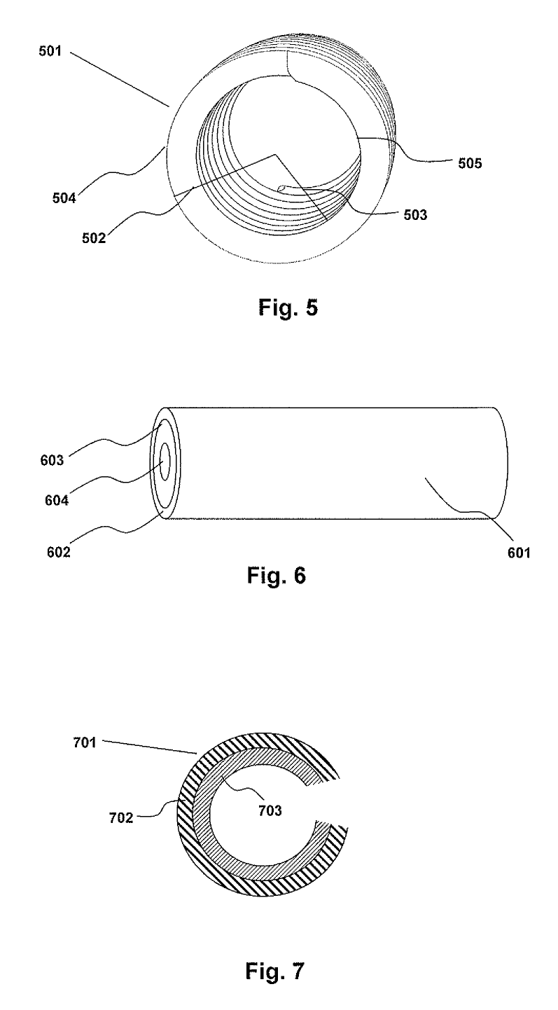

FIG. 5 illustrates a grip enhancer in its relaxed state and in accordance with aspects of the embodiments. The grip enhancer is illustrated as a coil 501 of grip material that is in its relaxed state because it is not wrapped around anything or being pulled out of shape. The loops in the coil have an outer radius 502 at the outside surface 504 of the coil and an inner radius 503 at the inside surface 505 of the coil. The coil will cling to any handle larger (in radius or diameter) than the inside radius. The coil will cling even better when the handle's circumference is larger than that of the inside surface.

FIG. 6 illustrates a rod 601 of grip enhancer material having a core layer 604 and two additional layers 602, 603 of material in accordance with aspects of some embodiments. Different materials have different properties. In one embodiment, a firm core layer can provide rigidity to the coil while a compliant outer layer can provide grip. In another embodiment, a firm outer layer can provide ruggedness while a compliant inner layer supports the outer layer. In yet another embodiment, a firm core 604 and outer layer 602 can provide rigidity and ruggedness while the more compliant middle layer 603 supports the outer layer 602 while also allowing the outer layer 602 to be somewhat compliant.

FIG. 7 illustrates a partial loop 701 of textured grip material in accordance with aspects of certain embodiments. The outside surface has an outer texture 702 that interfaces with a person's hand. The inside surface has an inside texture 703 that interfaces with the handle of a utensil, pot, pan, tool, or other item. Different textures work better for different purposes such as gripping a handle or being gripped by a hand. The textures 702, 703 can be surface patterns or shapes molded into or formed into the coil surfaces. The textures 702, 703 can also, or alternatively, be different materials, such as different types of food grade silicone rubber.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A grip enhancer for a utensil, the utensil comprising a handle having a handle circumference and the grip enhancer comprising:
a rod comprising a rubbery and elastic material wherein the rod is in the form of a coil comprising a plurality of loops wherein the loops, when in a relaxed state, have an inner diameter less than the handle circumference such that wrapping the grip enhancer around the handle causes the grip enhancer to hold onto the handle to thereby provide a person with an enhanced handle for the utensil, and wherein the loops return to the relaxed state once unwrapped from the handle.

2. The grip enhancer of claim 1 wherein the grip enhancer comprises food grade silicone rubber.

3. The grip enhancer of claim 2 wherein food grade silicone rubber is a soft grade of silicone rubber that easily deforms when gripped by a hand to thereby conform to the shape of the hand and to the shape of the handle.

4. The grip enhancer of claim 1 wherein the grip enhancer is dishwasher safe and chemically resistant.

5. The grip enhancer of claim 1 wherein the grip enhancer is textured to thereby increase the security with which the grip enhancer holds the handle and with which the person holds the enhanced handle.

6. The grip enhancer of claim 1 wherein the grip enhancer has an inner texture along the inside surface of the coil to thereby increase the security with which the grip enhancer holds the handle.

7. The grip enhancer of claim 6 wherein the inner texture comprises a molded-in pattern.

8. The grip enhancer of claim 6 wherein the inner texture comprises a silicone rubber having a firmness that differs from that of the body of the grip enhancer.

9. The grip enhancer of claim 1 wherein the grip enhancer has an outer texture along the outside surface of the coil such that the enhanced handle is textured.

10. The grip enhancer of claim 9 wherein the outer texture comprises a texture pattern.

11. The grip enhancer of claim 9 wherein the outer texture comprises a silicone rubber having a firmness that differs from that of the body of the grip enhancer.

12. The grip enhancer of claim 1 wherein the grip enhancer is thermally insulating.

13. The grip enhancer of claim 1 that when removably attached to the handle conforms to the handle and wherein the grip enhancer clings to the handle as the grip enhancer is wrapped around the handle due to the material's elasticity, and wherein the grip enhancer can be removed from the handle with minimal effort due to the material's elasticity.

14. A grip enhancer for a utensil, the utensil comprising a handle having a handle circumference and the grip enhancer comprising:
a rod comprising an outer layer and a core wherein the outer layer is a food grade silicone; and
a coil wherein the rod is a coiled rod, the coil comprises a plurality of loops wherein the loops, when in a relaxed state, have an inner circumference less than the handle circumference such that wrapping the grip enhancer around the handle causes the grip enhancer to hold onto the handle to thereby provide a person with an enhanced handle for the utensil, and wherein the loops return to the relaxed state once unwrapped from the handle.

15. The grip enhancer of claim 14 wherein the core is a silicone having a firmness that is different from the firmness of the food grade silicone.

16. A grip enhancer for a utensil, the utensil comprising a handle having a handle circumference and the grip enhancer comprising:
a rod made of silicone rubber and comprising at least one grade of silicone rubber comprising a food grade silicone rubber that easily deforms when gripped by a hand to thereby conform to the shape of the hand and to the shape of the handle;
a plurality of loops wherein the rod is a coiled rod such that the rod relaxes into a coil shape wherein the loops, when relaxed, have an inner circumference less than the handle circumference such that wrapping the grip enhancer around the handle causes the grip enhancer to cling to the handle to thereby provide a person with an enhanced handle for the utensil, and wherein the grip enhancer relaxes back into the coil shape once unwrapped from the handle.

17. The grip enhancer of claim 16 wherein the grip enhancer has an outer texture along the outside surface of the coil shape to thereby provide a textured enhanced handle for the person to hold.

18. The grip enhancer of claim 16 wherein the grip enhancer has an inner texture along the inside surface of the coil shape to thereby increase the security with which the grip enhancer holds the handle.

19. The grip enhancer of claim 18 wherein the grip enhancer has an outer texture along the outside surface of the coil shape to thereby provide a textured enhanced handle for the person to hold.

20. The grip enhancer of claim 19 wherein the rod comprises an outer layer and a core.
